(19) United States
(12) Patent Application Publication
(10) Pub. No.: US 2014/0049808 A1
(43) Pub. Date: Feb. 20, 2014

(54) PORTABLE PROJECTOR UTILIZING ELECTROPHORETIC DISPLAYS

(71) Applicant: Bo-Ru YANG, Bonqiao City (TW)

(72) Inventor: Bo-Ru YANG, Bonqiao City (TW)

(21) Appl. No.: 13/585,743

(22) Filed: Aug. 14, 2012

(51) Int. Cl. G02F 1/167; G02B 26/00

(52) U.S. Cl. CPC G02F 1/167; G02B 26/005
USPC 359/296; 359/290

(57) ABSTRACT

This invention is directed to a projector comprising a polarizer-free display device. Such a projector is more energy efficient while the switching speed is not compromised. The display device may be an electrophoretic display capable of lateral switching of the charged pigment particles in the display fluid, or an electrowetting display.

### FIELD OF THE INVENTION

This invention is directed to a projector comprising a polarizer-free display device. Such a projector is energy efficient while the switching speed is not compromised.

### BACKGROUND OF THE INVENTION

U.S. Pat. No. 5,844,588 describes a DMD (digital micro-mirror device)—modulated illumination system for exposing a xerographic printing apparatus. The system includes a DMD-type imaging spatial light modulator and a DMD-type optical switch for modulating the intensity of the source light irradiating the imaging DMD. A DMD is usually manufactured from a complicated fabrication process; therefore it could be costly when it is incorporated in a projector device.

Alternatively, a projector may be made by the Liquid Crystal on Silicon (LCoS) technology. An LCoS projector is a reflective projector similar to DLP (digital light processing) projectors. However, it uses liquid crystals instead of individual mirrors to modulate light. By way of comparison, a LCD projector uses transmissive LCD chips, allowing light to pass through the liquid crystals. In LCoS, liquid crystals are applied directly to the surface of a silicon chip coated with an aluminized layer, with some type of passivation layer, which is highly reflective. The LCoS technology can typically produce higher resolution and higher contrast images than standard liquid crystal display and plasma display technologies, which makes it less expensive to implement. However, a LCoS projector is not energy efficient.

### SUMMARY OF THE INVENTION

It has now been found that a fast-switching polarizer-free display device may be incorporated into a projector device as a light modulating component. The resulting projector is more energy efficient and the performance of the projector is not compromised.

One embodiment of the present invention is directed to a projector which comprises:

a) a light source;

b) an electrophoretic display as a light modulating component, wherein the electrophoretic display comprises an electrophoretic fluid in which charged pigment particles are capable of lateral switching; and optionally

c) a reflector layer.

If the reflector layer is present, it and the light source are on the opposite sides of the electrophoretic display.

The electrophoretic fluid may comprise one type of charged pigment particles. The charged pigment particles may be white or black.

The electrophoretic fluid comprises two types of pigment particles of contrasting colors and carrying opposite charge polarities.

The light source is a lamp, LED or laser. The projector may further comprise a color wheel. The electrophoretic fluid may be colored.

The electrophoretic fluid may be contained in micro-containers and the colors of the electrophoretic fluid in the micro-containers may be different.

The projector may further comprise color filters.

The projector may further comprise a ray collimator. The projector may further comprise a lens array. The projector may further comprise magnification lens.

The electrophoretic display may have a switching speed in the range of 120 Hz to 1000 Hz.

The electrophoretic fluid may have a liquid or gas medium.

The electrophoretic fluid may comprise a solvent which is a mixture of isoparaffins.

The projector may be a pico- or micro-projector.

A second embodiment of the present invention is directed to a projector which comprises
a) a light source;
b) an electrowetting display device; and optionally
c) a reflector layer.

If the reflector layer is present, it and the light source are on the opposite sides of the electrowetting display.

### BRIEF DESCRIPTION OF THE DRAWINGS

FIGS. 1 and 2 illustrate the present invention.

FIG. 3 depicts an alternative display option.

### DETAILED DESCRIPTION OF THE INVENTION

The present invention is directed to an energy efficient projector comprising a fast-switching polarizer-free display device as part of a light modulating component.

The present invention is especially suitable for portable-type projectors, such as pico-projectors or micro-projectors, as energy efficiency is important for small-size projectors. However, the present invention may be easily adapted to be incorporated into medium- or large-size projectors.

Generally, a projector comprises a light source, a ray collimator, a light modulating component, a color producing unit and a screen. The image is generated by this sequence—The light generated from the light source, collimated by an optical lens system, modulated by a light modulating component and then projected onto a screen.

According to the present invention, the light modulating component may be a display device, such as an electrophoretic display or an electro-wetting display.

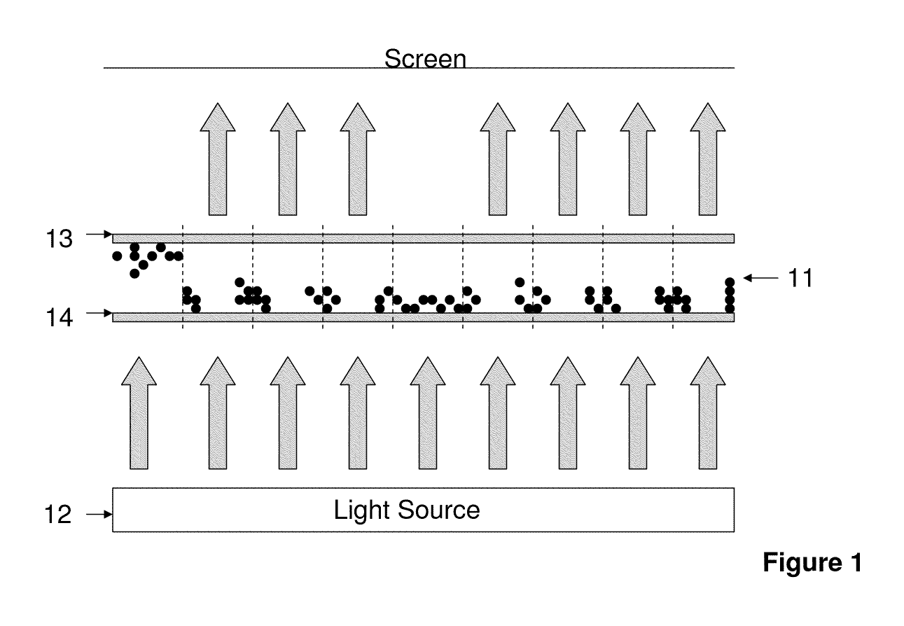

FIG. 1 illustrates one embodiment of the present invention in which an electrophoretic fluid layer (11) is sandwiched between two electrode layers (13 and 14). In the electrophoretic fluid layer, charged pigment particles are dispersed in a solvent or solvent mixture. Each space between the dotted lines denotes a pixel.

In the example as shown in FIG. 1, the fluid comprises only one type of pigment particles which are black and may be positively charged or negatively charged.

When a voltage potential difference is imposed between the two electrode layers, the charged pigment particles in the fluid would move, depending on the polarity of the charged pigment particles and the voltage potential difference.

The charged pigment particles may move laterally to allow the bottom of the pixels to be exposed or vertically to cover either the top or the bottom of the pixels. Lateral switching of the particles in a display device is an essential feature of the present invention. The term “lateral switching”, in the context of the present invention, is intended to refer to the switching of a display device to allow the light to pass through a pixel. For example, in the case of an electrophoretic display, the charged pigment particles, by lateral switching, are driven to the sides of a pixel to allow the light to pass through the pixel.

The lateral switching may be accomplished by in-plane switching where there are in-plane electrodes on one of the electrode layers to allow the charged pigment particles to move to the sides of the pixels. The in-plane switching mode is described in E. Kishi, et al., “5.1: development of In-Plane EPD”, Canon Research Center, SID 00 Digest, pages 24-27 (2000), Sally A. Swanson, et al., “5.2: High Performance Electrophoretic Displays”, IBM Almaden Research Center, SID 00 Digest, pages 29-31, (2000) and U.S. Pat. No. 6,885,495.

Alternatively, the lateral switching may be accomplished by a dual switching mode where the charged particles may move vertically and laterally, as shown in U.S. Pat. No. 7,046,228.

When a light source (12) emits light, some of the light may pass through the display device as the particles have been driven to the sides (i.e., light path open). When the particles are driven to be at the top or the bottom of a pixel, the light path is blocked (i.e., light path closed). Therefore by switching the charged pigment particles into different positions, an image formed on the display device may be projected onto a screen, utilizing the light passing through the display device.

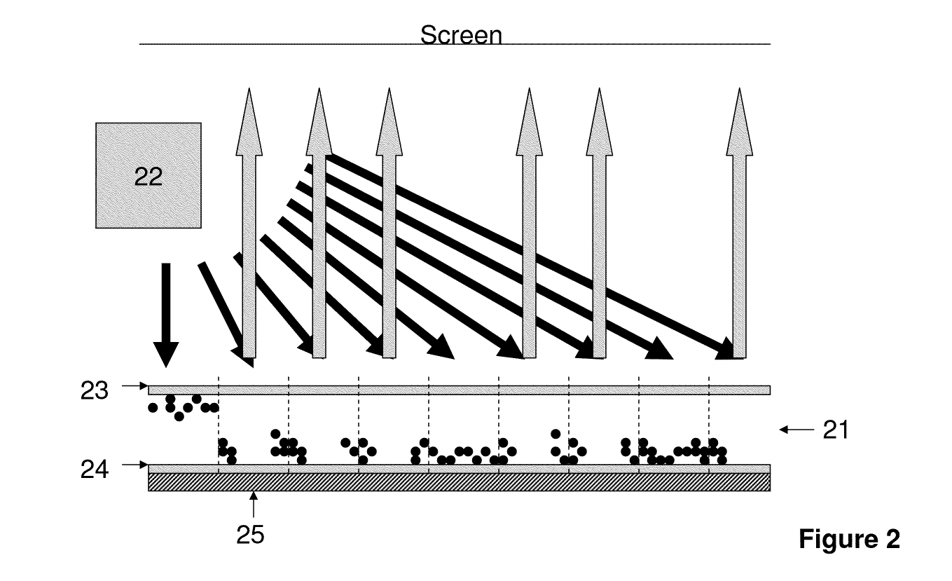

FIG. 2 depicts an alternative embodiment. As shown, an electrophoretic fluid layer (21) is sandwiched between two electrode layers (23 and 24). In this embodiment, there is a reflector layer (25). The light source (22) and the reflector layer are on the opposite sides of the display device. When the light source emits light and strikes the surface of the display device, some of the light is not reflected because the light path is blocked (i.e., light path closed) by the pigment particles whereas some of the light would be reflected by the reflector layer while the light path is not blocked (i.e., light path open). Therefore by switching the charged pigment particles into different positions, an image formed on the display device may be projected onto a screen, utilizing the light reflected from the reflector layer.

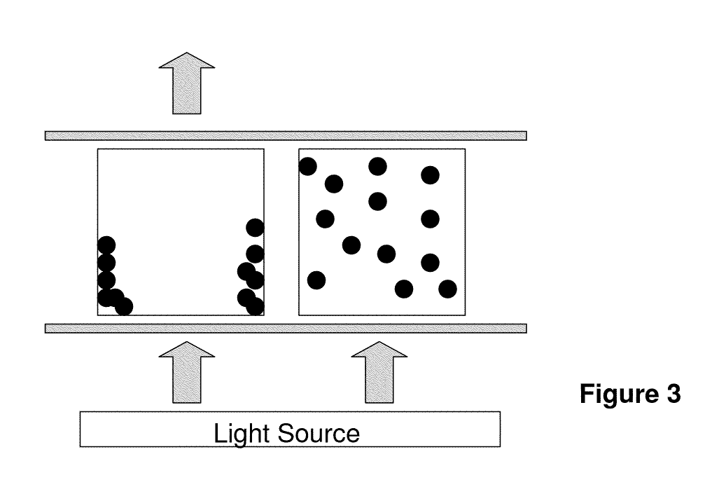

To block the light passage, as shown in FIGS. 1 and 2, the charged pigment particles are driven to the top or bottom of a pixel. However it is also possible to drive the charged pigment particles to be scattered in a display fluid to block the light passage, as shown in FIG. 3.

The light source can be a lamp, LED, laser or the like.

There are a variety of options that may be utilized to project images of color on a screen.

In one option, the light source may be a light-emitting diode module which emits light of different colors, such as white, red, blue, green, magenta, cyan, yellow or a combination thereof. In this option, a field-sequential color system is utilized, in which primary color information is transmitted in successive images and which also relies on the human vision system to fuse the successive images into images of color.

In another option, colors are produced by placing a color wheel between the light source and the display device. The color wheel is usually divided into four sections: the primary colors, red, green and blue, and an additional clear section to boost brightness. The movement of the charged pigment particles in the display device is synchronized with the rotating motion of the color wheel so that the green component is displayed when the green section of the color wheel is in front of the light source (which may be a lamp). The same is true for the red and blue sections. In this option, a field-sequential color system is also involved.

In a further option, the colors may be generated by dispersing the charged pigment particles in solvent of colors. For example, a pixel may consist of multiple micro-containers which are filled with an electrophoretic fluid of different colors.

In one embodiment, the micro-containers may be filled with an electrophoretic fluid of red, green and blue color, respectively. As a result, each pixel is capable of display at least five color states, red (i.e., when the light path in the red micro-container is open to let the light pass through while the light paths in the green and blue micro-containers are closed), green (i.e., when the light path in the green micro-container is open to let the light pass through while the light paths in the red and blue micro-containers are closed), blue (i.e., when the light path in the blue micro-container is open to let the light pass through while the light paths in the red and green micro-containers are closed), white (i.e., all three micro-containers are open) and black (all three micro-containers are closed). It is also possible to have a fourth micro-container in a pixel which does not have a color filter attached to it.

The term “micro-container” referred to may be microcups, microcapsules, microchannels or the like, as long as they may be filled with an electrophoretic fluid. All of these options are within the scope of the present invention.

In yet a further option, the micro-containers forming a pixel may have color filters of red, green or blue attached, to generate pixels of colors.

Between the light source and the electrophoretic display as the light modulating component, there are optional components.

For example, there may be a ray collimator whose aim is to have the light better controlled. In one embodiment, the ray collimator may have at least one collimator. In another embodiment, the ray collimator may have two collimators, in a front-back sequential arrangement with appropriate spacing, which may convert light from the light source into collimated light.

Another optional component is a lens array which homogenizes the collimated light. Preferably, the focus of each lens in the lens array is 2 mm-10 mm for superior effect.

A further optional component is magnification lens which can magnify the homogenized light with a predetermined ratio onto the light modulating component.

A ray collimator, a lens array and magnification lens, if all present, are preferably arranged in sequence with appropriate spacing in between. The purpose of this assembly is to control the light trace. However not all of these components must be present and, in fact, any of them may be added or eliminated by an optical designer, according to the design needs.

In FIGS. 1-3, the display fluid comprises only one type of charged pigment particles. However it is understood that the fluid may comprise two types of charged pigment particles of contrasting colors and carrying opposite charge polarities. It is also possible for the fluid to have more than two types of pigment particles (charged and/or non-charged).

The color of the charged pigment particles is also unlimited. They may be white, black or any other colors.

In order for the electrophoretic display to be an effective light modulating component in a projector, the switching speed of the display device is preferably in the range of 60 Hz to 1000 HZ, more preferably in the range of 120 Hz to 1000 Hz. The stated speed is defined as how many times a pixel is driven from fully “ON” to fully “OFF” (or vice versa) during the period of one second, and measured according to the normal optical set-up which can record the optical state change with time.

There are a variety of ways to achieve the stated speed for a fast-switching display device. For example, an electrophoretic fluid may comprise a gas medium with a response time in sub-milliseconds.

For an electrophoretic display device in which the charged pigment particles are dispersed in a solvent or solvent mixture, the switching speed may be increased by increasing the charge level of the particles. The charge strength of the charged pigment particles is preferably in the range of +/−20 mV to +/−200 mV, more preferably in the range of +/−40 mV to +/−150 mV.

Alternatively, the switching speed may be increased by reducing the depth of the micro-containers.

Further alternatively, the switching speed may be increased by adding additives to the electrophoretic fluid. Effective additives may include, but are not limited to, charge control agent, dispersant, surfactant or the like.

In yet another alternative, the switching speed may be increased by lowering the viscosity of the display fluid. In this case, the solvent or solvent mixture in which the charged pigment particles are dispersed is a component which may affect the switching speed. For example, the solvent or solvent mixture may be a mixture of hydrocarbon solvents, more preferably a mixture of isoparaffins.

The term “isoparaffin” refers to a group of saturated hydrocarbons which are branched. Usually, the isoparaffins have from 5 to 20 carbons and the solvents are clear and colorless.

The isoparaffin solvents are commercially available. For example, they are available under the trade name of Isopar® (by Exxon Mobil Chemical Company), Soltrol® (by Chevron Philips Chemical), Shellsole® (by Chevron Chemical), Isane® (by Total Petrochemicals) or Solane® (by Total Petrochemicals).

It is also noted that some of the solvent mixture may have a trace amount of aromatic species (i.e., less than 20 ppm) and/or an aniline point of between 55 to 70° C. These features may also be critical to improvement in the performance of an electrophoretic fluid comprising the solvent mixture.

The isoparaffin having a low carbon number tends to evaporate easier than those having a high carbon number. Therefore, to avoid evaporation-induced performance problems, isoparaffins having a low carbon number should be avoided in the solvent mixture, if possible.

It is also noted that one or more of the isoparaffins in the solvent mixture may be replaced with one or more linear or cyclic hydrocarbons, as long as the linear or cyclic hydrocarbon is compatible with the isoparaffins in the mixture. Such a solvent mixture is also within the scope of the present invention.

The isoparaffins are mixed in various ratios in the solvent mixture, and the ratios are determined based on the desired viscosity of the resulting mixture, which preferably is in the range of about 0.8 to about 1.5 (mm²/s at 25° C.).

In one embodiment of the present invention, the solvent mixture contains predominantly isoparaffins having 5-12 carbon atoms, preferably 7-12 carbon atoms and more preferably 8-12 carbon atoms.

In one embodiment, the weight percentage of any isoparaffins having less than 10 carbon atoms is less than about 40%, preferably less than about 30%, more preferably less than about 20% and most preferably less than about 10%, in the mixture.

In another embodiment, the weight percentage of any isoparaffins having more than 11 carbon atoms is less than about 30%, preferably less than about 20%, more preferably less than about 10% and most preferably less than about 5%, in the mixture.

In another embodiment, it is preferred that the solvent mixture has a Gaussian distribution of “weight percentage vs. carbon number” between 9-11 carbon atoms.

In another embodiment, it is preferred that the solvent mixture has about 1 to about 40% by weight of an isoparaffin of 9 carbon atoms. In one embodiment, the solvent mixture has about 1 to about 80% by weight of an isoparaffin of 10 carbons. In one embodiment, the solvent mixture has about 1 to about 40% by weight of an isoparaffin of 11 carbon atoms.

In one embodiment, the solvent mixture has about 30 to about 100% by weight of an isoparaffin of 10 carbon atoms.

In a further embodiment, the solvent mixture may have about 10% to about 30% by weight of an isoparaffin of 9 carbon atoms, about 30% to about 80% by weight of an isoparaffin of 10 carbon atoms, about 10% to about 30% by weight of an isoparaffin of 11 carbon atoms.

In a further embodiment, the solvent mixture may have less than about 30% by weight of an isoparaffin having more than 12 carbon atoms. In a further embodiment, the solvent mixture may have less than about 20% by weight of an isoparaffin having more than 12 carbon atoms. In a further embodiment, the solvent mixture may have less than about 10% by weight of an isoparaffin having more than 12 carbon atoms. In a further embodiment, the solvent mixture may have less than about 5% by weight of an isoparaffin having more than 12 carbon atoms. In a further embodiment, the solvent mixture may have less than about 1% by weight of an isoparaffin having more than 12 carbon atoms.

In a further embodiment, the solvent mixture may have less than about 80% by weight of an isoparaffin having more than 8 carbon atoms. In a further embodiment, the solvent mixture may have less than about 70% by weight of an isoparaffin having more than 8 carbon atoms. In a further embodiment, the solvent mixture may have less than about 50% by weight of an isoparaffin having more than 8 carbon atoms. In a further embodiment, the solvent mixture may have less than about 20% by weight of an isoparaffin having more than 8 carbon atoms. In a further embodiment, the solvent mixture may have less than about 10% by weight of an isoparaffin having more than 8 carbon atoms.

As an example, a suitable solvent mixture may have the following characteristics:

1) Density at 15° C. (ASTM D 4052) of 600˜805 kg/m3

2) Saybolt color of +20˜+30 (ASTM D 156)

3) Abel flash point of 10˜35° C. (EN-ISO 13736)

4) Aromatic content of 0.0002˜0.002 (% weight, TS IL 13 (U.V.)

5) Bromine index of 0˜30 mgBr/100 g (ASTM D 2710)

6) Aniline point of 0˜70° C. (ASTM 611)

7) Refractive index at 20° C. of 1.3˜1.5

8) Benzene content of 0˜10 ppm (ASTM D 6229)

9) Initial point of 120˜150° C. (ASTM D 86)

10) Dry point of 120˜180° C. (ASTM D 86)

While electrophoretic display is specifically mentioned, it is noted that electro-wetting display device may also be used. Electrowetting is a microfluidic phenomenon that may be used as a driving mechanism for a wide range of fluidic and electro-optic applications. Electrowetting involves modifying the surface tension of liquids on a solid surface using a voltage. By applying a voltage, the wetting properties of a hydrophobic surface can be modified and the surface becomes increasingly hydrophilic (wettable).

With electrowetting displays, the modification of the surface tension is used to obtain a simple optical switch by contracting a colored oil film electrically. Without a voltage, the colored oil forms a continuous film and the color is visible to the viewer. When a voltage is applied to a display pixel, the oil is displaced and the pixel becomes transparent. When different pixels are independently activated, the display can show images. The transmissive pixel may be used as the basis for reflective of transflective displays.

The high switching speed (a few milliseconds) of electrowetting and its applicability to small (pixel) dimensions means that electrowetting is ideally suited for application to the present invention.

While the present invention has been described with reference to the specific embodiments thereof, it should be understood by those skilled in the art that various changes may be made and equivalents may be substituted without departing from the true spirit and scope of the invention. In addition, many modifications may be made to adapt a particular situation, materials, compositions, processes, process step or steps, to the objective, spirit and scope of the present invention. All such modifications are intended to be within the scope of the claims appended hereto.

What is claimed is:

1. A projector comprising:
a) a light source;
b) an electrophoretic display as a light modulating component, wherein the electrophoretic display comprises an electrophoretic fluid in which charged pigment particles are capable of lateral switching; and optionally
c) a reflector layer.

2. The projector of claim 1, wherein if the reflector layer is present, the reflector layer and the light source are on the opposite sides of the electrophoretic display.

3. The projector of claim 1, wherein the electrophoretic fluid comprises one type of charged pigment particles.

4. The projector of claim 1, wherein the charged pigment particles are white.

5. The projector of claim 1, wherein the charged pigment particles are black.

6. The projector of claim 1, wherein the electrophoretic fluid comprises two types of pigment particles of contrasting colors and carrying opposite charge polarities.

7. The projector of claim 1, wherein the light source is a lamp, LED or laser.

8. The projector of claim 7, wherein the light source is LED.

9. The projector of claim 1, further comprising a color wheel.

10. The projector of claim 1, wherein the electrophoretic fluid is colored.

11. The projector of claim 9, wherein the electrophoretic fluid is contained in micro-containers and the colors of the electrophoretic fluid in the micro-containers are different.

12. The projector of claim 1, further comprising color filters.

13. The projector of claim 1, further comprising a ray collimator.

14. The projector of claim 1, further comprising a lens array.

15. The projector of claim 1, further comprising magnification lens.

16. The projector of claim 1, wherein the electrophoretic display has a switching speed in the range of 120 Hz to 1000 Hz.

17. The projector of claim 1, wherein the electrophoretic fluid has a gas medium.

18. The projector of claim 1, wherein the electrophoretic fluid comprises a solvent which is a mixture of isoparaffins.

19. The projector of claim 1, which is a pico- or micro-projector.

20. A projector comprising:
a) a light source;
b) an electrowetting display device; and optionally
c) a reflector layer.

21. The projector of claim 20, wherein if the reflector layer is present, the reflector layer and the light source are on the opposite sides of the electrowetting display.
